(19) United States
(12) Patent Application Publication
(10) Pub. No.: US 2008/0225241 A1
(43) Pub. Date: Sep. 18, 2008

(54) Projector and Method for adjusting projective luminance thereof

(76) Inventors: Jung-Chi Chen, Hsinchu (TW); Che-Hsueh Chen, Hsinchu (TW)

Correspondence Address: NORTH AMERICA INTELLECTUAL PROPERTY CORPORATION, P.O. BOX 506, MERRIFIELD, VA, 22116, US

(21) Appl. No.: 11/867,005

(22) Filed: Oct. 4, 2007

(30) Foreign Application Priority Data
Mar. 16, 2007 (TW) 096109221

(51) Int. Cl. G03B 21/20

(52) U.S. Cl. 353/85

(57) ABSTRACT

A projector includes a housing, a projecting module, a first luminance sensor, a second luminance sensor and a control module. The projecting module includes a light source for emitting light, a light valve for modulating the light into image light, and a projection lens for projecting the image light to a screen. The first luminance sensor senses the luminance of the image projected on the screen. The second luminance sensor senses the ambient luminance. The control module adjusts luminance of the light emitted from the light source according to sensed results of the two luminance sensors.

### BACKGROUND OF THE INVENTION

1. Field of the Invention

The present invention relates to a projector, and more particularly, to a projector capable of adjusting luminance of an image.

2. Description of the Prior Art

Generally speaking, when a projector is operated in a high luminance mode, it consumes more power and shortens the life span of a light bulb. Contrarily when a projector is operated in a low luminance mode, it consumes less power and the light bulb has a relatively longer life span. The luminance of a projector has to be properly determined to optimize the visual pleasure of viewers when applied in different occasions. For example, if the projector is too close to a screen and its luminance is not adjusted correspondingly, the luminance of the projected image will become exceedingly intense. If the projector is disposed too far from the screen and its luminance is not adjusted correspondingly, the luminance of the projected image will become too weak. If the projector is operated in a dark space and its luminance is not adjusted correspondingly, the projected image will appear to be too bright. If the projector is operated in a bright space and its luminance is not adjusted correspondingly, the projected image will appear to be too dark. In either of above cases, the luminance of the projected image makes the projected image undesirable.

To solve the above problems, a user has to adjust the projecting luminance of the projector according to the ambient luminance and the position of the projector relative to the screen by himself. If the user is not familiar with the projector, it will be a difficult task for the user to adjust the projector. Although there are some automatically adjustable projectors in prior arts, such as those taught by Taiwan Patent Publication No.00399742, and No.M261700, the projectors can only adjust the projecting luminance automatically according to the ambient luminance detected by a sensor. None of them takes the effect of a distance between the projector and the screen into consideration. Though the projector taught by Taiwan Patent Publication No. 00591955 senses RGB luminance of an image, and adjusts the RGB luminance accordingly, it fails to consider the ambient luminance and the distance between the projector and the screen. Further it fails to adjust the intensity of the light emitted by the light bulb, thus it cannot save power. The projector taught by Taiwan Patent Publication No. 200424741 utilizes a detecting module to detect distances from the projector to walls at the front, rear, left, and right sides of the projector, and then calculates the optimized distance between the projector and the screen so as to suggest the user the best position of the projector. However, this method still needs the user to adjust the position of the projector by himself, therefore this is not quite practical. Furthermore, it fails to consider the effect of the ambient luminance on the projected image.

### SUMMARY OF THE INVENTION

The present invention provides a projector capable of automatically switching to a desirable projection mode according to sensed luminance of an image projected on a screen and sensed ambient luminance so as to solve the aforementioned problems.

According to an embodiment of the present invention, a projector comprises a housing, a projecting module, a first luminance sensor and a control module. The projecting module is installed inside the housing and comprises a light source for emitting light, a light valve for modulating the light into image light, and a projection lens for projecting the image light onto a screen to form an image. The first luminance sensor is installed on the housing for sensing luminance of the image projected on the screen, and the control module is installed inside the housing, and coupled to the light source and the first luminance sensor for adjusting the luminance of the light emitted from the light source according to a sensed result of the first luminance sensor.

According to another embodiment of the present invention, a projector comprises a housing, a projecting module, a distance sensor, a luminance sensor, and a control module. The projecting module is installed inside the housing and comprises a light source for emitting light, a light valve for modulating the light into image light, and a projection lens for projecting the image light onto a screen to form an image. The distance sensor is installed inside the housing for sensing a distance between the projector and a screen, the luminance sensor is installed inside the housing for sensing ambient luminance of the projector, and the control module is installed inside the housing, and coupled to the light source, the distance sensor and the luminance sensor for adjusting luminance of light emitted from the light source according to sensed results of the distance sensor and the luminance sensor.

According to another embodiment of the present invention, a method of adjusting luminance of light emitted by a projector comprises sensing a distance between the projector and a screen, sensing ambient luminance of the projector, and adjusting the luminance of the light emitted from the projector according to the sensed results.

Other objectives, features and advantages of the present invention will be further understood from the further technology features disclosed by the present invention wherein there are shown and described preferred embodiments of this invention, simply by way of illustration of modes best suited to carry out the invention.

### BRIEF DESCRIPTION OF THE DRAWINGS

FIG. 1 is a block diagram of a projector according to an embodiment of the present invention.

FIG. 2 is a perspective view of the projector in FIG. 1.

FIG. 3 is a flow chart of a method for adjusting luminance of an image projected on a screen according to the embodiment of the present invention.

FIG. 4 shows a relationship between the luminance of the image projected on the screen, ambient luminance, and projection mode according to the embodiment of the present invention.

FIG. 5 shows relationships between the luminance of the image projected on the screen, the ambient luminance, and the projection mode before and after their relationship is updated according to the embodiment of the present invention.

### DETAILED DESCRIPTION

It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless limited otherwise, the terms “connected,” and “coupled,” and “mounted,” and variations thereof herein are used broadly and encompass direct and indirect connections, couplings, and mountings.

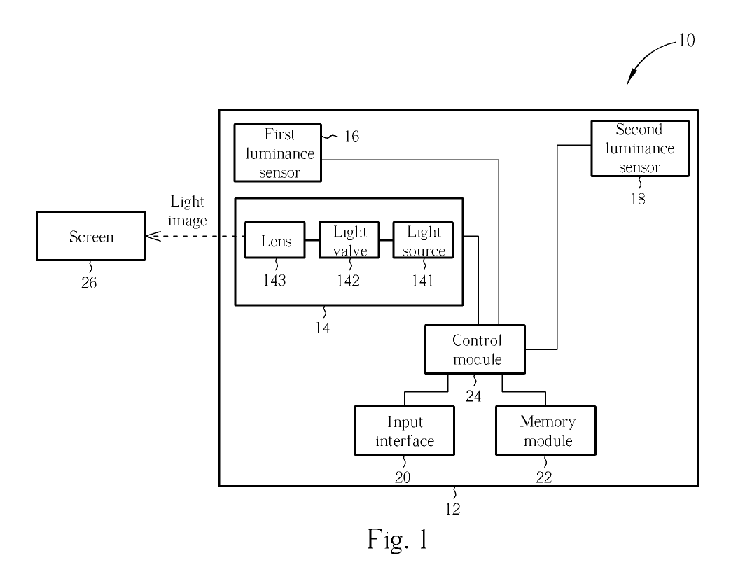

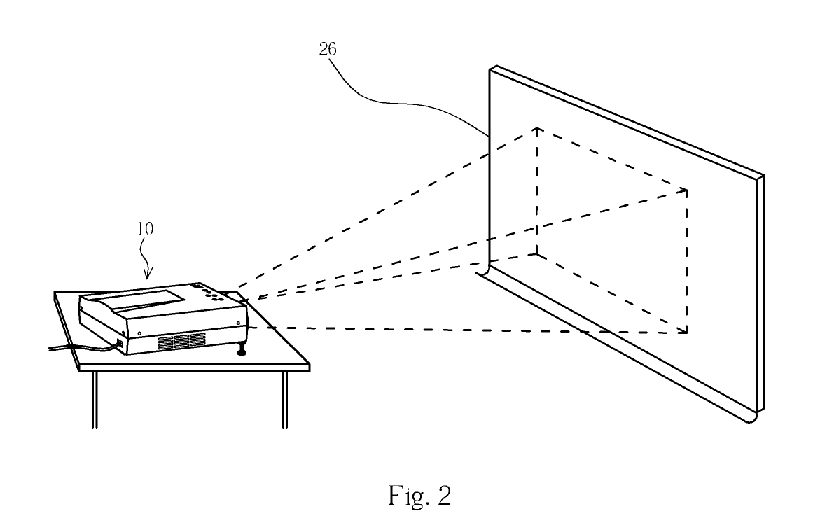

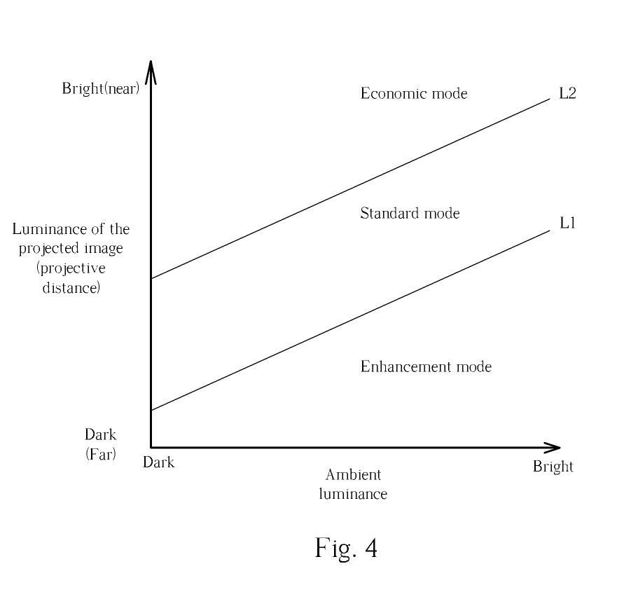

Please refer to FIG. 1 and FIG. 2. A projector 10 according to one embodiment of the present invention comprises a housing 12, a projecting module 14, a first luminance sensor 16, a second luminance sensor 18, an input interface 20, a memory module 22, and a control module 24. The housing 12 is capable of housing internal parts of the projector 10. The projecting module 14 is installed inside the housing 12 and comprises a light source 141 for emitting light, a light valve 142 for modulating the light into image light, and a projection lens 143 for projecting the image light onto a screen 26 to form an image. The first luminance sensor 16 is installed on the housing 12 and disposed adjacent to the projection lens 143 for sensing luminance of the image projected on the screen 26. The first luminance sensor 16 is a phototransistor, for example a photistor, or a photodiode, for example a PIN photodiode, an avalanche photodiode, or a photo resistor. Alternatively the first luminance sensor 16 is replaced by a distance sensor, for example MaxSonar-EZ1, a high-efficiency ultra sound wave detector for sensing a distance between the projector 10 and the screen 26 in order to determine the proper projecting luminance of the projector 10. The second luminance sensor 18 is installed on the housing 12 and disposed away from the projection lens 143 for sensing ambient luminance. The second luminance sensor 18 is a phototransistor, for example a photistor, or a photodiode, for example a PIN photodiode, an avalanche photodiode, or a photo resistor. The input interface 20 is coupled to the control module 24 for adjusting luminance of the light emitted from the light source 141 and is for example implemented by a human-machine interface such as a keyboard or a touch screen. The memory module 22 is installed inside the housing 12 and coupled to the control module 24 for storing a relationship between the luminance of light emitted by the light source 141 adjusted by the input interface 20, the luminance of the image sensed by the first luminance sensor 16, the ambient luminance sensed by the second luminance sensor 18, and projection modes of the projector comprising an economic mode, a standard mode, and an enhancement mode. However the projection modes are not confined to only these three modes, they can be alternatively designed to satisfy different requirements. Please refer to FIG. 4. FIG. 4 shows three projection modes according to an embodiment of the present invention. In FIG. 4, the horizontal axis refers to the ambient luminance. The vertical axis refers to the luminance of the image. The projection modes comprise an enhancement mode triggered when a result under the first curve L1 is determined, a standard mode triggered when a result between the first curve L1 and the second curve L2 is determined, and an economic mode triggered when a result above the curve L2 is determined. The control module 24 is installed inside the housing 12 and coupled to the light source 141, the first luminance sensor 16, the second luminance sensor 18, the input interface 20, and the memory module 22 for adjusting the luminance of light emitted from the light source 141 according to the sensed results of the first luminance sensor 16 and the second luminance sensor 18. When the projection mode is the economic mode, the control module 24 drives the light source 141 with a low power, when the projection mode is the standard mode, the control module 24 drives the light source 141 with a medium power, when the projection mode is the enhancement mode, the control module 24 drives the light source 141 with a high power. In this embodiment the low power is 200 W, the medium power is 230 W, and the high power is 260 W.

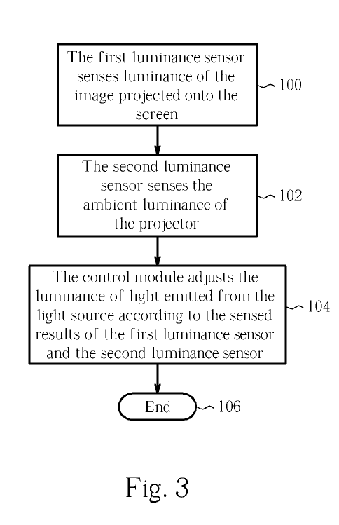

Please refer to FIG. 3, a method of adjusting the luminance of the image emitted from the projector 10 comprises the first luminance sensor 16 sensing the luminance of the image projected on the screen 26 (step 100), the second luminance sensor 18 sensing the ambient luminance of the projector 10 (step 102), the control module 24 adjusting the luminance of light emitted from the light source 141 according to the sensed results of the first luminance sensor 16 and the second luminance sensor 18 (step 104), and the end (step 106).

The aforementioned steps are explained in greater detail as follows. In step 100, the first luminance sensor 16 is, for example, a photo-sensor for sensing the luminance of the image projected on the screen 26. The photo-sensor converts light signals into electric signals and then transfers the electric signals to the control module 24. Further, the first luminance sensor 16 can be replaced with a distance sensor for sensing the distance between the projector 10 and the screen 26. Likewise, in step 102, the second luminance sensor 18 is a photo-sensor for sensing the ambient luminance. It converts light signals into electric signals and then transfers the electric signals to the control module 24.

In step 104, the control module 24 adjusts the luminance of light emitted from the light source 141 according to the sensed results of the first luminance sensor 16 and the second luminance sensor 18. This is implemented by switching the projector 10 into the economic mode, the standard mode, or the enhancement mode according to the results of step 100 and 102. Please refer to FIG. 4, which is a chart showing a relationship between the luminance of the image, the ambient luminance, and the projection mode. The relationship is stored in the memory module 22. The steps of the present invention further comprise enhancing the luminance of the image emitted from the projector 10 when sensing the distance between the projector 10 and the screen 26 is increased, and reducing the luminance of the image emitted from the projector 10 when sensing the distance between the projector 10 and the screen 26 is decreased; or further comprise enhancing the luminance of the image emitted from the projector 10 when sensing ambient luminance of the projector 10 is increased, and reducing the luminance of the image emitted from the projector 10 when sensing the ambient luminance of the projector 10 is decreased. For example, when the luminance of the image projected on the screen 26 is too dark (or the projecting module 14 is too far away from the screen 26), the luminance of light emitted from the light source 141 needs to increase, so the projector 10 is switched to the enhancement mode. When the luminance of the image projected on the screen 26 is too bright (or the projecting module 14 is too close to the screen 26), the luminance of light emitted from the light source 141 needs to decrease, so the projector 10 is switched to the economic mode not only for decreasing the luminance of light but also for saving power and prolonging the life span of the light source 141. When the luminance of the image projected on the screen 26 is neither too bright nor too dark (or the projecting module 14 is neither too close nor too far away from the screen 26), the projector 10 is switched to the standard mode. Moreover, when the ambient luminance of the projector 10 becomes too bright, the luminance of light emitted from the light source 141 needs to increase, so the projector 10 is switched to the enhancement mode. When the ambient luminance of the projector 10 becomes too dark, the luminance of light emitted from the light source 141 needs to decrease, so the projector 10 is switched to the economic mode not only for decreasing the luminance of light but also for saving power and prolonging the life span of the light source 141. When the ambient luminance of the projector 10 becomes neither too bright nor too dark from being too bright or too dark, the projector 10 is switched to the standard mode. Therefore, the control module 24 switches the projection mode according to the relationship illustrated in FIG. 4.

Furthermore, the steps in the present invention further comprise adjusting the luminance of light emitted from the projector 10 through the input interface 20 of the projector 10. That means the user can adjust the luminance of light emitted from the light source 141 through the input interface 20 by himself. If the user is not satisfied with the projection mode determined by the control module 24, the user can switch to his desired projection mode through the input interface 20. The steps in the present invention further comprise adjusting the luminance of light emitted from the projector 10 according to the sensed results of step 100 and step 102, and the projection mode selected by the user through the input interface 20. That means the projector 10 of the present invention is capable of learning. The memory module 22 stores the relationship between the luminance of the image projected on the screen 26 sensed by the first luminance sensor 16, the ambient luminance of the projector 10 sensed by the second luminance sensor 18, and the projection mode selected by the user through the input interface 22. Then the control module 24 updates the relationship between the luminance of the image, the ambient luminance, and the projection mode after accumulating a certain amount of data in the memory 22.

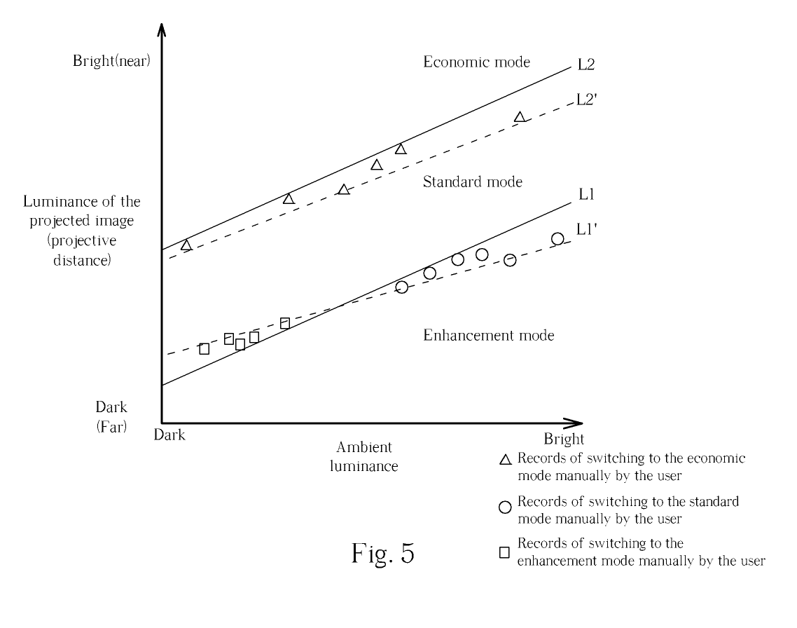

Please refer to FIG. 5. FIG. 5 shows relationships between the luminance of the image, the ambient luminance, and the projection mode before and after the relationship is updated according to the embodiment of the present invention. In FIG. 5, each of the triangular marks represents the user manually switches the projection mode to the economic mode, each of the circular marks represents the user manually switches the projection mode to the standard mode, each of the square marks represents the user manually switches the projection mode to the enhancement mode. The solid lines L1 and L2 represent the original relationship between the luminance of the image, the ambient luminance, and the projection mode. The dashed lines L1′ and L2′ represent the updated relationship between the luminance of the image, the ambient luminance, and the projection mode. The steps in the present invention further comprise switching the projector 10 to the economic mode, the standard mode, or the enhancement mode through the input interface 20 of the projector 10; and switching the projector 10 to the economic mode, the standard mode, or the enhancement mode according to the sensed results of the steps 100 and 102, and the projection mode manually selected by the user through the input interface 20. It is concluded from FIG. 5 that the user often switches the projector 10 to the economic mode through the input interface 20 after the standard mode is determined by the control module 24. Therefore the line L2 is replaced with the line L2′. Then the control module 24 switches the projection mode according to the updated relationship between the luminance of the image sensed by the first luminance sensor 16 and the ambient luminance sensed by the second luminance sensor 18. The learning process of the projector 10 is not limited to the above implementation. Another example can be that when the sensed results of the luminance of the image sensed by the first luminance sensor 16 and the ambient luminance sensed by the second luminance sensor 18 are the same as those in one recorded former case, and a projection mode has been manually selected in the former case, then the control module 24 automatically sets the projection mode the same as which in the former case.

Compared to the prior art, the projector of the present invention determines the most desirable projection mode automatically according to the sensed results of the luminance of the image projected on the screen and the ambient luminance. Therefore, the projector projects a high quality image, saves power, produces low noise, and prolongs the life span of the light source 141.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projector comprising:
a housing;
a projecting module installed inside the housing, the projecting module comprising:
a light source for emitting light;
a light valve for modulating the light into image light; and
a projection lens for projecting the image light onto a screen to form an image;
a first luminance sensor installed on the housing for sensing the luminance of the image; and
a control module installed inside the housing and coupled to the light source and the first luminance sensor for adjusting the luminance of the light emitted from the light source according to a sensed result of the first luminance sensor.

2. The projector of claim 1, wherein the first luminance sensor is a phototransistor, a photodiode, or a photo resistor.

3. The projector of claim 1, further comprising an input interface coupled to the control module for adjusting the luminance of the light emitted from the light source manually.

4. The projector of claim 3, further comprising a memory module installed inside the housing and coupled to the control module for storing a relationship between the luminance of the light emitted from the light source adjusted by the input interface and the luminance of the image sensed by the first luminance sensor.

5. The projector of claim 1, further comprising a memory module installed inside the housing and coupled to the control module for storing a relationship between the luminance of the light emitted from the light source and the luminance of the image sensed by the first luminance sensor.

6. The projector of claim 1, further comprising a second luminance sensor installed on the housing and coupled to the control module for sensing the ambient luminance of the projector, the control module adjusting the luminance of the light emitted from the light source according to sensed results of the first luminance sensor and the second luminance sensor.

7. The projector of claim 6, wherein the first luminance sensor is disposed near the projection lens and the second luminance sensor is disposed away from the projection lens.

8. A projector comprising:
a housing;
a projecting module installed inside the housing, the projecting module comprising:
a light source for emitting light;
a light valve for modulating the light into image light; and
a projection lens for projecting the image light onto a screen to form an image;
a distance sensor installed on the housing for sensing a distance between the projector and the screen;
a luminance sensor installed on the housing for sensing the ambient luminance of the projector; and
a control module installed inside the housing and coupled to the light source, the distance sensor and the luminance sensor for adjusting the luminance of the light emitted from the light source according to sensed results of the distance sensor and the luminance sensor.

9. The projector of claim 8, further comprising an input interface coupled to the control module for adjusting the luminance of the light emitted from the light source manually.

10. The projector of claim 9, further comprising a memory module installed inside the housing and coupled to the control module for storing a relationship between the luminance of the light emitted from the light source adjusted by the input interface and the sensed result of the distance sensor.

11. The projector of claim 8, further comprising a memory module installed inside the housing and coupled to the control module for storing a relationship between the luminance of the light emitted from the light source and the sensed result of the distance sensor.

12. A method of adjusting the luminance of an image light projected by a projector, the method comprising:
(a) sensing a distance between the projector and the screen;
(b) sensing the ambient luminance of the projector; and
(c) adjusting the luminance of the light emitted by the projector according to sensed results of the step (a) and the step (b).

13. The method of claim 12, further comprising:
(d) adjusting the luminance of the light emitted from the projector through an input interface.

14. The method of claim 13, further comprising adjusting the luminance of the light emitted from the projector according to the sensed results of the step (a), the step (b) and the adjusted result of the step (d).

15. The method of claim 13, wherein the step (d) utilizes the input interface of the projector to switch the projector into an economic mode, a standard mode, or an enhancement mode.

16. The method of claim 15, further comprising switching the projector into the economic mode, the standard mode, or the enhancement mode according to the sensed results of the step (a), the step (b) and the adjusted result of the step (d).

17. The method of claim 12, wherein the step (c) is switching the projector into an economic mode, a standard mode, or an enhancement mode according to the sensed results of the step (a), and the step (b).

18. The method of claim 12, wherein the step (c) comprises enhancing the luminance of the light emitted from the projector when sensing the distance between the projector and the screen is increased, and reducing the luminance of the light emitted from the projector when sensing the distance between the projector and the screen is decreased.

19. The method of claim 12, wherein step (c) comprises enhancing the luminance of the light emitted from the projector when sensing the ambient luminance of the projector is increased, and reducing the luminance of the light emitted from the projector when sensing the ambient luminance of the projector is decreased.
